(19) United States
(12) Patent Application Publication
(10) Pub. No.: US 2007/0289199 A1
(43) Pub. Date: Dec. 20, 2007

(54) Fishing tackle and bait holster

(76) Inventor: Michael Brian Looney, Chester, NJ (US)

Correspondence Address: MICHAEL LOONEY, 115 ROUTE 206 SOUTH, CHESTER, NJ, 07930, US

(21) Appl. No.: 11/453,328

(22) Filed: Jun. 14, 2006

(51) Int. Cl. A01K 97/06; A01K 97/08

(52) U.S. Cl. 43/54.1; 43/26; 220/920

(57) ABSTRACT

The present invention is directed to fishing tackle carriers and, more specifically, provides an improved and novel type of fishing tackle carrier. The device includes a main body with a variety of pockets and pouches. Attached to the main body is an expandable pouch with a liner to hold live bait; cylindrical sleeves are attached in main body seams to provide a holding compartment for a fishing rod.

### BACKGROUND OF THE INVENTION

1. Field of the Invention

The present invention is directed to fishing tackle carriers and, more specifically, provides an improved and novel type of fishing tackle carrier. The device includes a main body with a variety of pockets and pouches. Attached to the main body is an expandable pouch with a liner to hold live bait; cylindrical sleeves are attached in main body seams to provide a holding compartment for a fishing rod.

2. Information Disclosure Statement

Conventional tackle storage devices are presently available in a variety of configurations, which permit storage of spare or surplus fishing tackle. However, no prior art device teaches a holster shaped, fabric fishing tackle carrier, with a variety of compartments, with a specific live bait pouch, and rod holding sleeve to facilitate improved storage and access to fishing items. The following patents describe the present state of the art, which reference to fishing itemcarrying devices. U.S. Pat. No. 1,198,202 to Kenton Drinkard teaches a fishing device for holding a fishing rod in a fishing position allowing hands free usage. This device, however, does not hold live bait or tackle and necessitates a plurality of mechanics to achieve its simple function. U.S. Pat. No. 1,549,400 to Herman Wimler teaches a waist worn bait and tackle box made of rigid material allowing for hinged lids and compartments. However, this device is not designed to hold a fishing rod. The bait containers are too small and unable to achieve the versatility of a fabric construction. U.S. Pat. No. 2,691,400 to Peter Giordano teaches a shoulder bag with a plurality of compartments for storing fishing tackle and does not allow for use as a waist belt device or rod holder. U.S. Pat. No. 2,817,472 to Merle Parkhurst teaches a fishing belt with compartments incorporated with a pair of inflatable elements allowing the belt to act as a life preserver. However, the cylindrical compartments severely limit use. There is no means for holding live bait or supporting a fishing rod while being worn. U.S. Pat. No. 3,638,843 to Samuel Ortynski teaches a lure and fly carrier made of rigid material with multiple compartments with a single hinged lid severely limiting its functionality. There is no means for storing live bait or supporting a fishing rod while being worn. U.S. Pat. No. 3,917,134 to Alvin Tumline teaches a fishing carrier comprised of a tray providing three upward opening compartments. A forwardly extending fishing rod socket is attached to the main body tray. All described parts of the carrier are fabricated from metal, plastic or similar materials causing said device to be cumbersome and impractical. The rigid design limits storage as well as creates potential for breakage. U.S. Pat. No. 4,323,181 to John Spasoff teaches a rectangular belt mounted carrier fabricated from a semi-rigid material and comprising a bait jar holder, fishing rod support compartment, and utility compartment. This device is comprised of spring hinged covered compartments of limited use and restrictive accessibility as well as a multitude of breakable and irreplaceable components making it both impractical and costly. The subsequent lack of storage necessitates a second tackle carrier thereby further reducing its functionality. U.S. Pat. No. 4,529,112 to George Miller teaches a carrier for fishing rods and tackle supported by a shoulder strap. The carrier comprises a carrier plate, a tackle box pivotally mounted to a carrier plate, a plurality of fishing rod holders for holding fully assembled rods and reels or disassembled sections of fishing rods thereon. However, this device is designed for transporting gear not for use while fishing. U.S. Pat. No. 5,397,040 to Jeffrey Lee teaches a fishing tackle waist belt and pack consisting of individual storage compartments retaining generally rigid containers within a single fabric pack supported by a belt. However, there is no means of holding a fishing rod. Furthermore, the removable compartments risk being lost or broken as well as not providing specific storage for live bait. U.S. Pat. No. 5,619,819 to Alan Hauschild teaches wrap around carrying case comprising a rod holding case, shot gun case, and accessory carrier. However, this carrier, when worn, has no application for holding a fishing rod or live bait. Furthermore, said device is not designed specifically for fishing. U.S. Pat. No. 5,975,393 to John Bellamy teaches a backpack consisting of a bottom portion, front panel, and side panels defining an interior space for holding fishing rods therein. However, this is specifically for carrying equipment and does not allow for use while fishing. Furthermore, it does not provide for storing of live bait. U.S. Pat. No. 6,267,276 to James Cook teaches a fishing bag with a rod carrier consisting of a shoulder strap and waist strap attached to a carrier to be worn by a fisherman which facilitates holding a fishing rod by means of a supporting fabric loop, a connecting ring, and a rod suspension clip. However, this bag has no specific use or compartments as well as no means to facilitate for storage of live bait. Furthermore, the rod support system disclosed therein requires the use of both hands as well as a multitude of components to achieve its objective. U.S. Pat. No. 4,569,466 to Louis Webber teaches a belt mounted rod holder comprised of a flat base with two rigid support loops. However, the. holder does not facilitate any means of storing tackle or bait thereby severely limiting its use. U.S. Pat. No. 6,382,490 to Michael Divincenzo teaches a fishing tackle box worn about the waist including a cover panel hingedly coupled thereto exposing a front section defined by a plurality of compartments being slidably disposed therein. However, the tackle box has no means for supporting a fishing rod. Furthermore, the rigid construction and system of draws causes said device to be cumbersome as well as impractical. Notwithstanding the prior art, the present invention is neither taught nor rendered obvious thereby.

### SUMMARY OF THE INVENTION

The following detailed description is of a preferred arrangement of the invention and, although changes could be made to that which is specifically herein described and shown in the included drawings, for sake of briefness of this disclosure, all of these changes which fall within the scope of the present invention have not herein been detailed but should be apparent to those skilled in the art. In view of the foregoing disadvantages inherent in the known types of fishing tackle carriers now present in the prior art, the present invention provides an improved fishing tackle carrier to be worn about the waist wherein the same can be utilized for a variety of functions not presently provided for in the prior art. It is an object of the invention to provide an improved carrier for fishing tackle, which is adapted to be worn in conjunction with a waist belt. It is another object of the invention to provide a carrier which allows for secure storage and easy access to live bait. It is another object of the invention to provide a variety of compartments for storing and accessing fishing tackle therein. It is a further object of the invention to provide a cylindrical sleeve to facilitate supporting and suspending a fishing rod from the carrier. An even further object of the invention is to provide a new and improved carrier for fishing tackle using reinforced fabric in conjunction with main body, rod supports, and compartments construction. There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto. These, together with other advantages of the invention, along with the various features of novelty, which characterizes the invention, will be better understood from a reading of the remaining specifications and claims and from a study of the appended drawings.

### BRIEF DESCRIPTION OF THE DRAWINGS

FIG. 1 shows a front view of a preferred embodiment of the present invention.

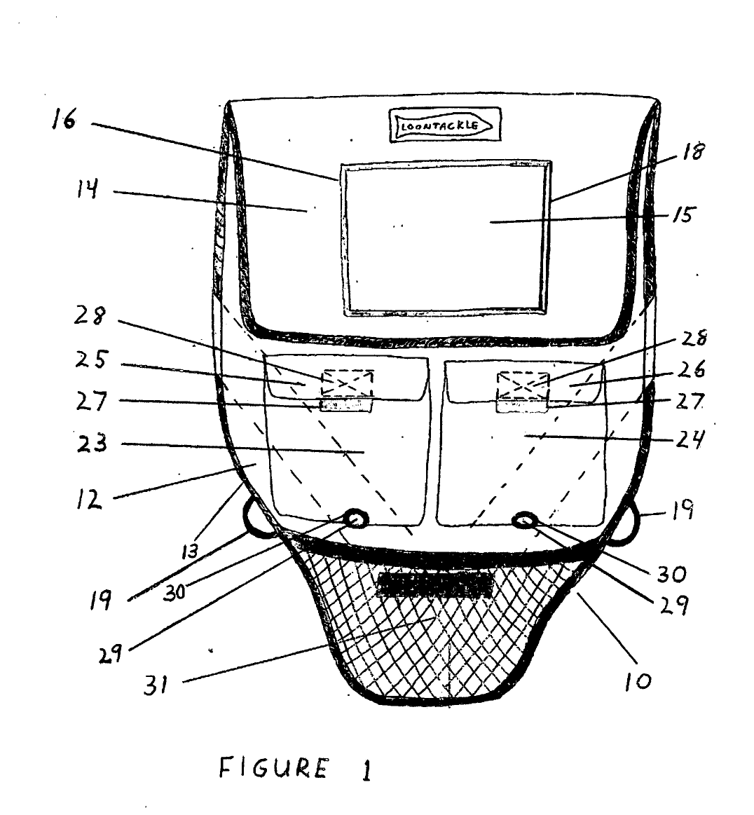

FIG. 2 shows a front open view of a preferred embodiment of the present invention.

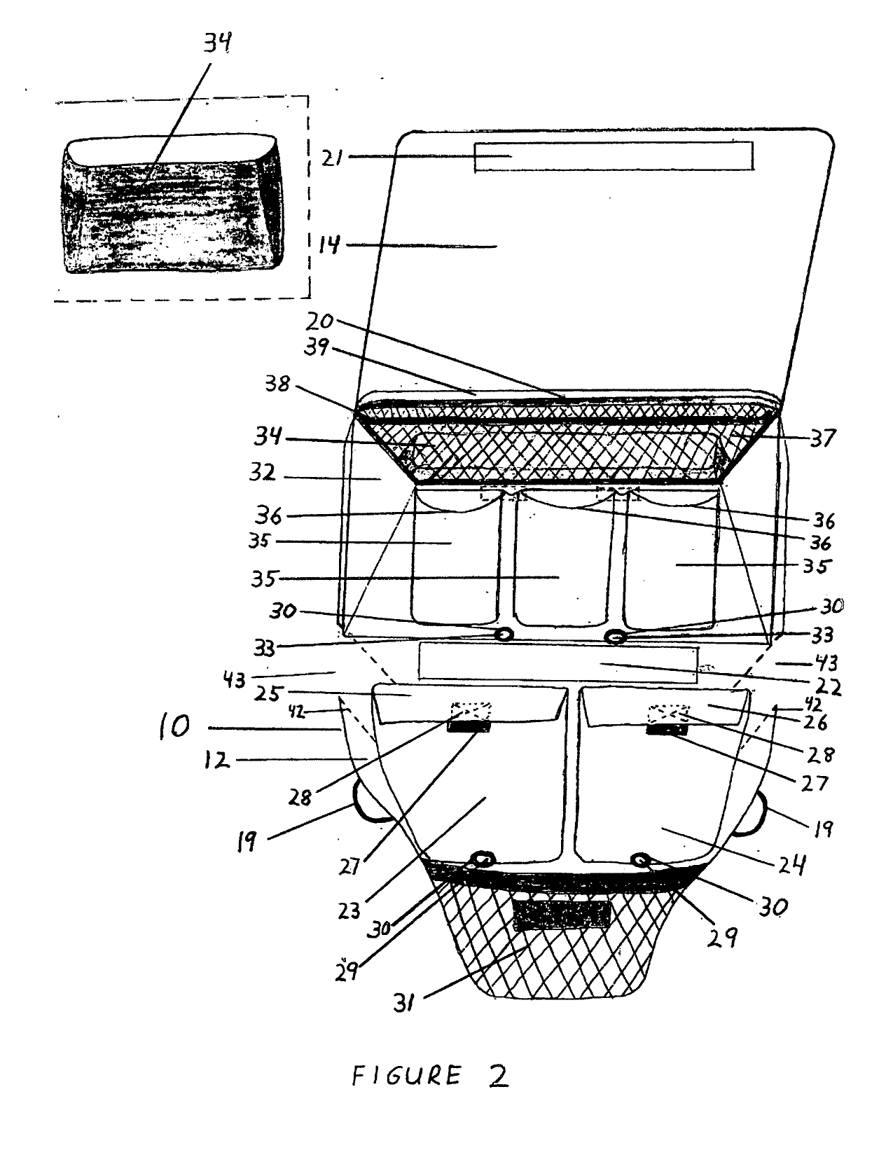

FIG. 3 is a back view of a preferred embodiment of the present invention. Additionally shown is a cross section view illustrating interior compartments.

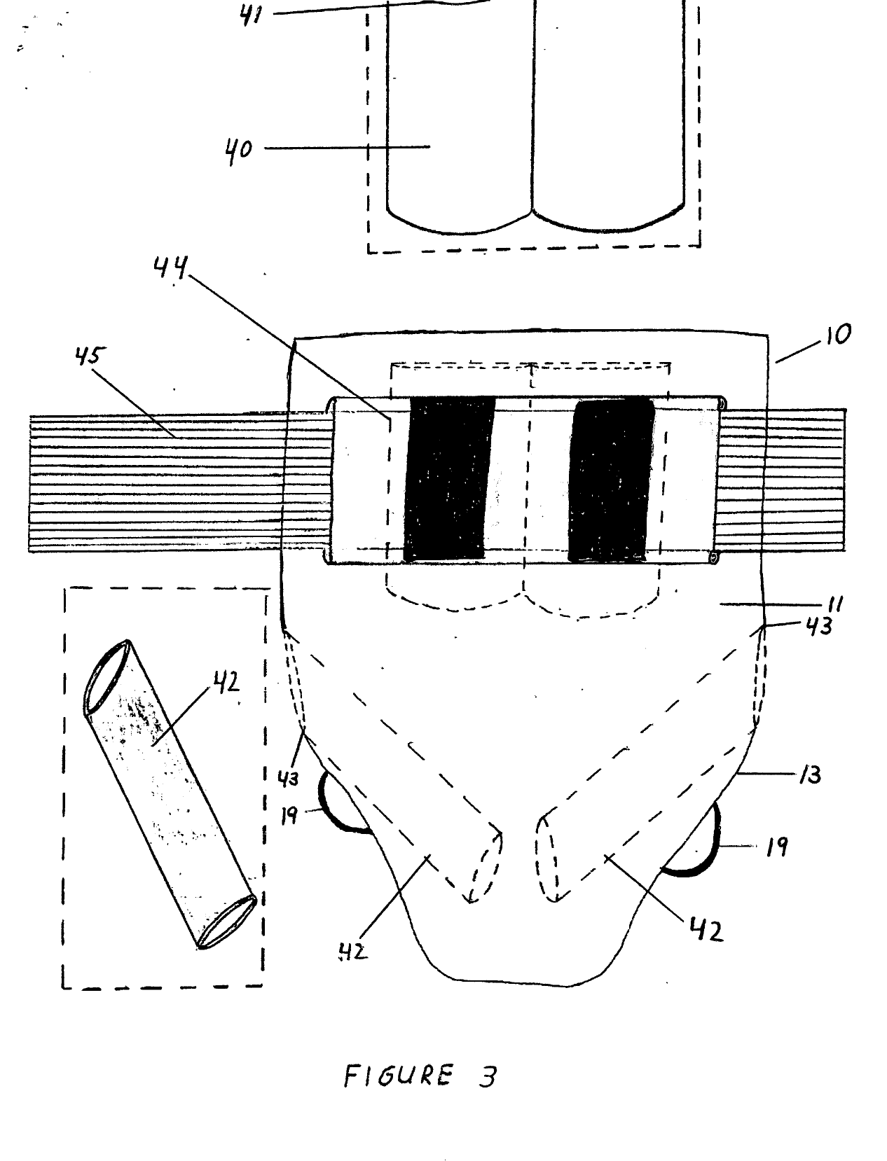

FIG. 4 is a side view of a preferred embodiment of the present invention.

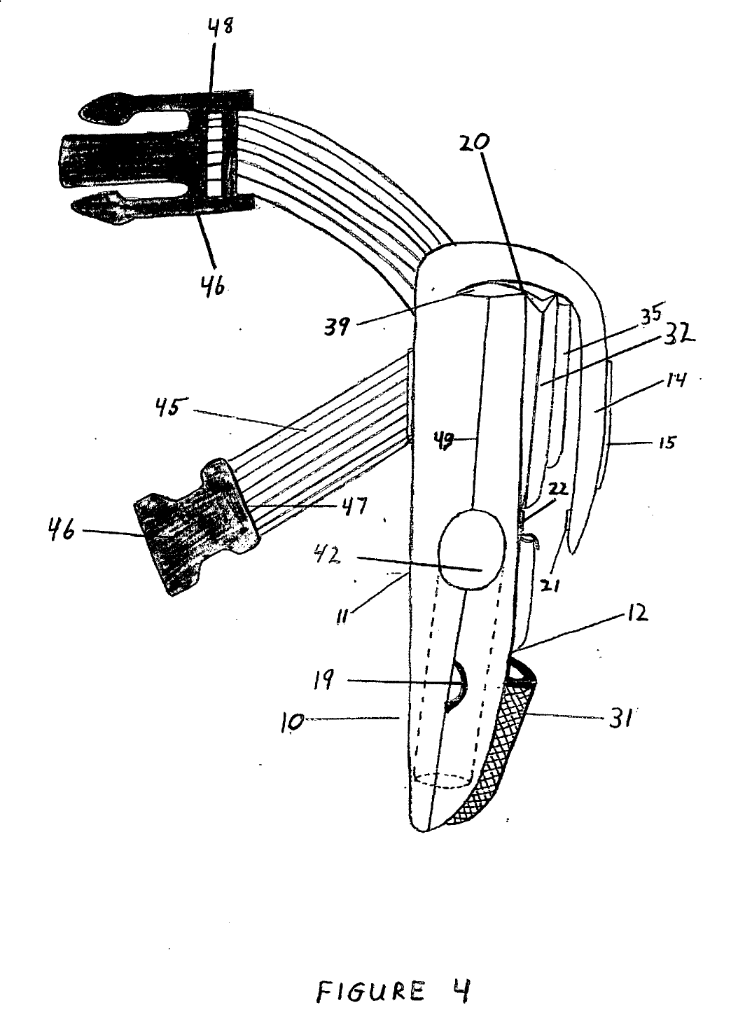

### DETAILED DESCRIPTION OF THE PRESENT INVENTION

With reference now to the drawings, and in particular, to figures one through four thereof, the preferred embodiment of the new and improved belt mounted fishing tackle carrier embodying the principles and concepts of the present invention and generally designated by the reference number 10 will be described.

Specifically, it will be noted in the various figures that the device relates to a belt mounted fishing tackle carrier for holding all items needed for fishing wherein allowing for easy access and functionality. In its broadest context, the device described herein consists of a holster style carrier with compartments of varying sizes, a live bait pouch, rod holding sleeve, utility rings, and a belt. Such components are individually configured and correlated with respect to each other so as to attain the desired objective.

The carrier 10 embodies in its construction a holster style pouch, generally comprising flexible water repellent material, such as, nylon, waxed cotton, plastic, or other such substance and embodies in its construction a back wall 11 and a front wall 12 wherein back wall 11 is substantially longer allowing for a cover flap 14 to fold over the top of front wall 12. Front panel 12 is connected to back panel 11 along two oppositely disposed edges 49, the top edge 20 of front panel 12 notwithstanding, which is essentially a continuation of seam 13, preferably by stitching, glue, rivets or other suitable means thereby creating a pouch configuration 39, with a cover flap 14. Cover flap 14 carries a fastener element 21, preferably VELCRO (RTM), snaps or other known fasteners, for coaction with a fastener element 22 on the outside surface of front panel 12 so as to sustain the former in a closed position. Said back and front panels are preferably double layer envelopes, which may contain support filling. Affixed by sewing or any other suitable arrangement to the front exposed surface of cover flap 14, is a pocket 15, for retaining and displaying a fishing license or similar document. The pocket 15 is constructed of a clear or transparent material, such as, vinyl or like plastics, preferably having a framing 16, of leather or fabric or other suitable material and thereby attached to the outer front surface of cover flap 14 along the two oppositely disposed top and bottom edges as well as one side edge, leaving one edge unattached and therefore open 18 to allow for insertion and removal of a fishing license. Utility rings 19 are attached into seam 13 on the left and right edges of the lower half of pouch 10. Preferably two compartments, 23 and 24, made of flexible water repellent material, such as, nylon, waxed cotton, plastic or other such suitable matter, each with cover flaps 25 and 26, are attached to the outside surface of front panel 12, just below main body cover flap fastener 22. Attached to compartments 23 and 24 are fastener elements 27 designed for coaction with fastener elements 28 attached to cover flaps 25 and 26 so as to sustain the latter in a closed position. Drainage holes 29, preferably affixed with grommets 30 or other suitable materials, are cut into the bottom area of compartments 23 and 24. An elastic type net pouch 31 is affixed to lower area of the outside surface of front panel 11 below compartments 23 and 24. An expandable live bait pouch 32 is attached to the upper outer surface of front panel 11 , just above fastener element 22, allowing for cover flap 14 to conceal pouch 32 and its contents. Preferably two drainage holes 33, affixed with grommets 30, or other suitable materials, are cut into bottom area of pouch 32. A removable liner 34, preferably made of a flexible water repellant material, such as, nylon, waxed cotton, or plastic is fitted within the bait pouch 32. A plurality of compartments 35, made of a clear or transparent substance, allowing for identification of items within and affixed to the outside surface of bait pouch along the bottom and oppositely disposed side edges to leave the top edge 36 unattached and therefore open to allow for insertion and removal of said items. A bait cover 37, preferably comprising an elastic type netting or similar material, with an expandable access slit 38 is attached by stitching, glue or other means across the top opening of expandable bait pouch 32. The interior of the main compartment 39, preferably includes two utility pouches 40, made of flexible water repellent material, such as, nylon, waxed cotton, plastic or a similar substance which are attached to interior wall of back panel 11 by stitching, glue or similar means along the bottom and two oppositely disposed side edges of each compartment 40, leaving the top edges 41, unattached and therefore open for insertion and removal of items. A tubular fishing rod holder device 42, preferably comprising double layers of flexible water repellent material, such as, nylon, waxed cotton, plastic or other suitable substance, preferably reinforced with plastic liner or similar material, is attached to left and right side of main body 10 by means of glue, stitching or by any other means recognized by an artisan, through an opening 43, in seam 13. A transversely elongated belt sleeve 44, preferably made of flexible water repellent material or similar substance, is attached to the outside of back panel 11 by stitching, glue, rivets or other suitable means. A waist belt in general accordance with the present invention comprises a flexible belt 45, sized for placement around a human waist. Belt 45, may be made of nylon webbing, leather or other suitable flexible materials, and preferably includes mating snap fasteners 46 at the two free ends 47 and 48. The snap fasteners 46 are preferably quick release types which are secure when connected to one another, yet quick to disconnect, and could also be hook and loop type fasteners or a more conventional buckle type fastening arrangement. There is an arrangement within the belt 45, and belt fastener 46, to allow the adjusting of the belt diameter. With respect to the above description then, it is to be realized that the optimum dimensional relationships for the parts of the invention to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described and, accordingly, all suitable modifications and equivalents may be resorted to falling within the scope of the invention.

Having thus described my invention what I claim as new and desire to secure letters patent is:

1. A waist belt mounted fishing tackle carrier comprising: a carrier having a front panel and a back panel, wherein attached outside edges of said front and back panels are defined by a seam, said front panel and said back panel having an exterior and interior, said interior defining an interior space; and said front panel having its upper edge spaced downwardly from the upper edge of said back panel, wherein a main cover flap is formed over said front panel by folding the upwardly extending portion of said back panel there over.

2. A belt mounted fishing tackle carrier, according to claim 1, wherein exterior of main cover flap includes a pocket for retaining a fishing license, with said pocket being at least in part transparent for displaying of a fishing license.

3. A belt mounted fishing tackle carrier, according to claim 1, having a live bait storage compartment attached to the exterior of said front panel and concealed by said main cover flap.

4. A belt mounted fishing tackle carrier, according to claim 1, having at least one utility storage compartment having a cover flap wherein said utility storage compartment is attached to exterior of said front panel.

5. A belt mounted fishing tackle carrier, according to claim 1, having at least one utility ring attached to said seam of front and back panels.

6. A belt mounted fishing tackle carrier, according to claim 1, having an elastic net storage pouch affixed to exterior of said front panel.

7. A belt mounted fishing tackle carrier, according to claim 3, having a removable liner for said live bait storage compartment.

8. A belt mounted fishing tackle carrier, according to claim 3, having an elastic net cover affixed to top edges of said live bait storage compartment.

9. A belt mounted fishing tackle carrier, according to claim 3, having a plurality of transparent storage compartments affixed to exterior of said live bait storage compartment.

10. A belt mounted fishing tackle carrier, according to claim 1, wherein the live bait storage compartment, according to claim 3, the utility storage compartments according to claim 4, and the interior space according to claim 1, include vent holes through which water and small debris may pass.

11. A belt mounted fishing tackle carrier, according to claim 1, wherein said main cover flap, and the utility storage compartment cover flaps according to claim 4, comprises a hook and loop fastener or its equivalent for retaining same in a closed position.

12. A belt mounted fishing tackle carrier, according to claim 1, having at least one fishing rod holder device positioned to facilitate supporting and suspending a fishing rod and affixed through opening in said main body seam.

13. A belt mounted fishing tackle carrier, according to claim 1, having at least one storage compartment affixed to interior of said back panel.

14. A belt mounted fishing tackle carrier, according to claim 1, having a means for accommodating a waist belt, wherein said means is affixed to exterior of said back panel.

15. A belt mounted fishing tackle carrier, according to claim 1, having a flexible belt with means of connecting opposing ends of said belt as well as means of adjusting diameter of said belt, for placement around a waist.

16. A belt mounted fishing tackle carrier, according to claim 1, wherein said belt mounted fishing tackle carrier is a holster shaped device thus having a longer lateral dimension than horizontal as well as being tapered inwardly from top to bottom.

17. A belt mounted fishing tackle carrier, according to claim 1, wherein said belt mounted fishing tackle carrier being constructed of water resistant material.

18. A belt mounted fishing tackle carrier, according to claim 1, comprising; a live bait storage compartment attached to the exterior of said front panel and concealed by said main cover flap, at least one utility storage compartment having a cover flap wherein said utility storage compartment is attached to exterior of said front panel, at least one rod holding device angularly positioned to facilitate supporting and suspending a fishing rod and affixed through opening in said main body seam.
